(19) United States
(12) Patent Application Publication
(10) Pub. No.: US 2026/0239394 A1
(43) Pub. Date: Aug. 13, 2026

(54) HYPER FRAME NUMBER INDICATION

(71) Applicant: QUALCOMM Incorporated, San Diego, CA (US)

(72) Inventors: Arnaud MEYLAN, San Diego, CA (US); Soo Bum LEE, San Diego, CA (US); Sherif ELAZZOUNI, San Diego, CA (US); Arun Prasanth BALASUBRAMANIAN, San Diego, CA (US)

(21) Appl. No.: 19/051,464

(22) Filed: Feb. 12, 2025

(51) Int. Cl. H04W 72/30

(52) U.S. Cl. CPC H04W 72/30

(57) ABSTRACT

Various aspects of the present disclosure generally relate to wireless communication. Some aspects relate to explicitly indicating a hyper frame number (HFN) in a wireless communication between a transmitter and a receiver. In some aspects, the transmitter may transmit, to the receiver, a communication that carries an indication of the HFN, which may help to prevent the receiver from missing a packet data convergence protocol sequence number rollover event.

### FIELD OF THE DISCLOSURE

Aspects of the present disclosure generally relate to wireless communication and specifically relate to techniques, apparatuses, and methods associated with indicating a hyper frame number.

### BACKGROUND

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, or radio frequency (RF) sensing, among other examples.

A hyper frame number (HFN) is a value, which may be represented as a sequence of bits, that is used by network and a user equipment (UE) to perform various wireless communication operations. To perform effective wireless communication, a value of the HFN at the network should match a value of the HFN at the UE. However, because HFN values are independently monitored at the network and the UE, these values can become mismatched, which can lead to communication failures.

### SUMMARY

Some aspects described herein relate to an apparatus for wireless communication at a wireless communication device. The apparatus may include one or more memories storing processor-executable code and one or more processors coupled with the one or more memories. At least one processor of the one or more processors configured to cause the wireless communication device to communicate a packet data convergence protocol (PDCP) protocol data unit (PDU) comprising a header that includes an indication of a count value including a hyper frame number (HFN). At least one processor of the one or more processors configured to cause the wireless communication device to perform one or more security operations using the HFN and a PDCP sequence number (SN) associated with the HFN.

Some aspects described herein relate to an apparatus for wireless communication at a wireless communication device. The apparatus may include one or more memories storing processor-executable code and one or more processors coupled with the one or more memories. At least one processor of the one or more processors configured to cause the wireless communication device to communicate a control element that indicates a HFN. At least one processor of the one or more processors configured to cause the wireless communication device to perform one or more security operations using the HFN and a PDCP SN associated with the HFN.

Some aspects described herein relate to an apparatus for wireless communication at a wireless communication device. The apparatus may include one or more memories storing processor-executable code and one or more processors coupled with the one or more memories. At least one processor of the one or more processors configured to cause the wireless communication device to communicate an indication of a HFN that includes one or more most significant bits of a system frame number (SFN). At least one processor of the one or more processors configured to cause the wireless communication device to perform one or more security operations using the HFN and a PDCP SN associated with the HFN.

Some aspects described herein relate to a method of wireless communication performed at a wireless communication device. The method may include communicating a PDCP PDU comprising a header that includes an indication of a count value including a HFN. The method may include performing one or more security operations using the HFN and a PDCP SN associated with the HFN.

Some aspects described herein relate to a method of wireless communication performed at a wireless communication device. The method may include communicating a control element that indicates a HFN. The method may include performing one or more security operations using the HFN and a PDCP SN associated with the HFN.

Some aspects described herein relate to a method of wireless communication performed at a wireless communication device. The method may include communicating an indication of a HFN that includes one or more most significant bits of a SFN. The method may include performing one or more security operations using the HFN and a PDCP SN associated with the HFN.

Some aspects described herein relate to an apparatus for wireless communication. The apparatus may include means for communicating a PDCP PDU comprising a header that includes an indication of a count value including a HFN. The apparatus may include means for performing one or more security operations using the HFN and a PDCP SN associated with the HFN.

Some aspects described herein relate to an apparatus for wireless communication. The apparatus may include means for communicating a control element that indicates a HFN. The apparatus may include means for performing one or more security operations using the HFN and a PDCP SN associated with the HFN.

Some aspects described herein relate to an apparatus for wireless communication. The apparatus may include means for communicating an indication of a HFN that includes one or more most significant bits of a SFN. The apparatus may include means for performing one or more security operations using the HFN and a PDCP SN associated with the HFN.

Some aspects described herein relate to a non-transitory computer-readable medium that stores a set of instructions for wireless communication by a wireless communication device. The set of instructions, when executed by one or more processors of the wireless communication device, may cause the wireless communication device to communicate a PDCP PDU comprising a header that includes an indication of a count value including a HFN. The set of instructions, when executed by one or more processors of the wireless communication device, may cause the wireless communication device to perform one or more security operations using the HFN and a PDCP SN associated with the HFN.

Some aspects described herein relate to a non-transitory computer-readable medium that stores a set of instructions for wireless communication by a wireless communication device. The set of instructions, when executed by one or more processors of the wireless communication device, may cause the wireless communication device to communicate a control element that indicates a HFN. The set of instructions, when executed by one or more processors of the wireless communication device, may cause the wireless communication device to perform one or more security operations using the HFN and a PDCP SN associated with the HFN.

Some aspects described herein relate to a non-transitory computer-readable medium that stores a set of instructions for wireless communication by a wireless communication device. The set of instructions, when executed by one or more processors of the wireless communication device, may cause the wireless communication device to communicate an indication of a HFN that includes one or more most significant bits of a SFN. The set of instructions, when executed by one or more processors of the wireless communication device, may cause the wireless communication device to perform one or more security operations using the HFN and a PDCP SN associated with the HFN.

Aspects of the present disclosure may generally be implemented by or as a method, apparatus, system, computer program product, non-transitory computer-readable medium, user equipment, base station, network node, network entity, wireless communication device, or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example associated with indicating a hyper frame number (HFN).

FIG. 3 is a flowchart illustrating an example process performed, for example, at a wireless communication device or an apparatus of a wireless communication device that supports one or more first aspects for indicating a HFN.

FIG. 4 is a flowchart illustrating an example process performed, for example, at a wireless communication device or an apparatus of a wireless communication device that supports one or more second aspects for indicating a HFN.

FIG. 5 is a flowchart illustrating an example process performed, for example, at a wireless communication device or an apparatus of a wireless communication device that supports one or more third aspects for indicating a HFN.

FIG. 6 is a diagram of an example apparatus for wireless communication that supports indicating a HFN.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures or functionalities in addition to or other than the structures or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Wireless communications may be split into various layers. The layers may include a Layer 1 (L1) (also referred to as a physical (PHY) layer), a Layer 2 (L2), a Layer 3 (L3), and so forth. In some examples, a layer may be split into sublayers. For example, L2 may include a packet data convergence protocol (PDCP) sublayer, a radio link control (RLC) sublayer, and a medium access control (MAC) sublayer, among other examples. Each layer or sublayer may be responsible for a given set of services or functions that facilitate wireless communication. For example, the PDCP sublayer may handle sequence numbering, PDCP protocol data unit (PDU) routing, or security operations, among other examples. The security operations may include encryption (such as ciphering), decryption (such as deciphering), integrity protection, or message authentication, among other examples.

The PDCP sublayer may perform security operations using a PDCP count (also referred to as “PDCP COUNT” or “COUNT”). A PDCP count is a concatenation of a hyper frame number (HFN) and a PDCP sequence number (SN). The PDCP count may be 32 bits. For example, the HFN may be 14 bits and the PDCP SN may be 18 bits, or the HFN may be 20 bits and the PDCP SN may be 12 bits.

The PDCP SN (and, thus, the PDCP count) may be incremented for each PDCP data PDU that is transmitted during a radio resource control (RRC) connection between a network and a user equipment (UE). The PDCP SN may be explicitly indicated in a PDCP PDU, and a HFN may be monitored locally by PDCP entities of the network and the UE. For example, when a PDCP SN transitions from a maximum PDCP SN value to a minimum PDCP SN value (“rolls over”), the network and the UE may both independently increment the HFN (for example, using heuristics).

In some examples, the network and the UE may become desynchronized (“out-of-sync”) with respect to the HFN. For example, the network and the UE may assign different values of the HFN to the same PDCP PDU. For example, due to buffer overflow or backhaul loss, the network may lose a significant quantity of PDCP PDUs, which may represent more than half of the PDCP SN space. Thus, when the PDCP SN rolls over, the network, which increments the PDCP SN for the lost PDCP PDUs, may increment the HFN; however, the UE, which is not aware of the lost PDCP PDUs and therefore may not increment the PDCP SN for the lost PDCP PDUs, may not increment the HFN upon PDCP SN rollover. As a result, the HFN monitored at the network may not match the HFN monitored at the UE. Such out-of-sync HFN values can lead to communication failures, which may impact the quality of voice calls or impede security operations (such as deciphering), among other examples.

Various aspects relate generally to proactively preventing HFN out-of-sync scenarios. Some aspects more specifically relate to explicitly indicating the HFN in a wireless communication between a transmitter (for example, one of the network and the UE) and a receiver (for example, the other of the network and the UE). In some aspects, the transmitter may transmit, to the receiver, a communication that carries an indication of the HFN, which may help to prevent the receiver from missing a PDCP SN rollover event.

In some aspects, the transmitter may include, in the header of a PDCP packet, an indication of the HFN. In some examples, the transmitter may include an entire PDCP count in each header. In some examples, the transmitter may include an entire PDCP count in the header if the HFN has changed.

In some aspects, the transmitter may include an indication of the HFN in a control element, such as a MAC control element (MAC-CE) or a PDCP control PDU. The transmitter may include the indication of the HFN in a control element once per transport block (TB) or when the HFN changes.

In some aspects, the transmitter may provide, and the receiver may derive, the HFN via one or more broadcast or unicast over-the-air communications. For example, the HFN may be a concatenation of a broadcast system sub-frame number (SSFN), one or more most significant bits of a broadcast system frame number (SFN), and a unicast tag.

Particular aspects of the subject matter described in this disclosure can be implemented to realize one or more of the following potential advantages. In some examples, the described techniques can be used to prevent communication failures, such as by improving the quality of voice calls or facilitating security operations (such as deciphering), among other examples. For example, instead of relying on local monitoring (which can lead to HFN out-of-sync), the receiver may use the communication that carries the indication of the HFN as an explicit indication that the HFN has incremented. As a result, the receiver may remain synchronized with the transmitter with respect to the HFN.

Including the indication of the HFN in the header of the PDCP packet may help to prevent communication failures in high-throughput scenarios. For example, high-throughput scenarios may support inclusion of the entire PDCP count in a header.

Including the indication of the HFN in the control element may help to prevent communication failures using reduced overhead. For example, the control element may be transmitted infrequently, thereby reducing bandwidth allocated for communication the indication of the HFN.

The HFN being a concatenation of the SSFN, the one or more most significant bits of the SFN, and the tag may help to prevent communication failures in high-throughput scenarios, such as for short PDCP SN rollover periods. For example, the HFN may include an appropriate quantity of bits from the SSFN, the one or more most significant bits of the SFN, and the tag such that the HFN increments fast enough to ensure that the PDCP SN does not roll over before the HFN increments.

As described above, wireless communication systems may be deployed to provide various services, which may involve carrying or supporting voice, text, other messaging, video, data, or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies or support one or more of the foregoing use cases or new use cases.

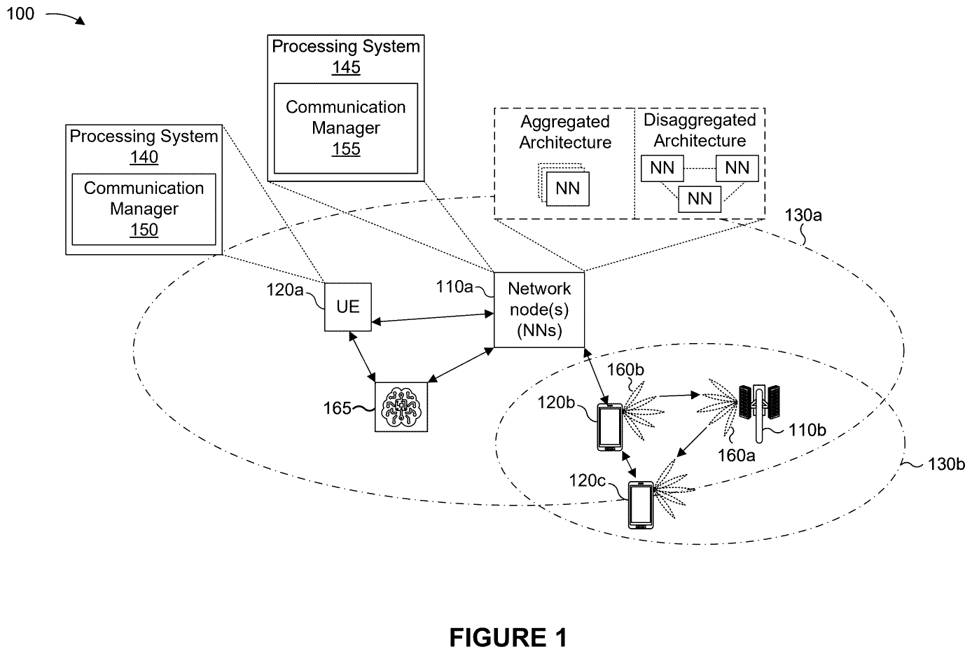

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, or that are included in mid-band frequencies. Similarly, the term “millimeter wave,” if used herein, may broadly refer to mid-band frequencies or to frequencies that are within FR2, FR4, FR4-a or FR4-1, FR5, or the EHF band. Higher frequency bands may extend 5G NR operation, 6G operation, or other RATs beyond 52.6 GHz.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 or the processing system 145 include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Alternatively, and as also shown, a network node 110 may be a disaggregated network node (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a RRC layer, a PDCP layer, and a service data adaptation protocol (SDAP) layer, among other examples. A DU may host one or more of a RLC layer, a MAC layer, or one or more higher PHY layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, or disaggregated network nodes, among other examples. Various different types of network nodes 110 may generally transmit at different power levels, serve different coverage areas (for example, a cell 130a and a cell 130b), or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, or any other suitable device or function that may communicate via a wireless medium.

Some UEs 120 may be classified according to different categories in association with different complexities or different capabilities. UEs 120 in a first category may facilitate massive IoT in the wireless communication network 100, and may offer low complexity or cost relative to UEs 120 in a second category. UEs 120 in a second category may include mission-critical IoT devices, legacy UEs, baseline UEs, high-tier UEs, advanced UEs, full-capability UEs, or premium UEs that are capable of URLLC, eMBB, or precise positioning in the wireless communication network 100, among other examples. A third category of UEs 120 may have mid-tier complexity or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, or an NR-Lite UE, among other examples. RedCap UEs may bridge a gap between the capability and complexity of NB-IoT devices or eMTC UEs, and mission-critical IoT devices or premium UEs. RedCap UEs may include, for example, wearable devices, IoT devices, industrial sensors, or cameras that are associated with a limited bandwidth, power capacity, or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 or UE 120 may communicate using massive MIMO, multi-user MIMO, or single-user MIMO, which may involve rapid switching between beams or cells. For example, the amplitudes or phases of signals transmitted via antenna elements or sub-elements may be modulated and shifted relative to each other (such as by manipulating a phase shift, a phase offset, or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, or a vertical direction), a set of parameters that indicate one or more aspects of a directional signal, a direction associated with the signal, or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 or at the UE 120, such as in a network implementing mmWave technology. Massive MIMO may improve communication reliability by enabling a network node 110 or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network transmission, or non-coherent joint transmission (NC-JT).

To support MIMO techniques, the network node 110 and the UE 120 may perform one or more beam management operations, such as an initial beam acquisition operation, one or more beam refinement operations, or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state or a quasi co-location (QCL) parameter, among other examples. The network node 110 and the UE 120 may increase reliability or achieve efficiencies in throughput, signal strength, or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, or one or more servers, or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases such as beam management, radio resource monitoring (RRM) relaxation, mobility prediction, load prediction, network energy savings, or coverage and capacity improvements, among other examples.

In some aspects, a wireless communication device, such as the network node 110 or the UE 120, may include a communication manager, such as communication manager 150 or 155. As described in more detail elsewhere herein, the communication manager 150 or 155 may communicate a PDCP PDU comprising a header that includes an indication of a count value including a HFN; and perform one or more security operations using the HFN and a PDCP SN associated with the HFN. Additionally or alternatively, the communication manager 150 or 155 may communicate a control element that indicates a HFN; and perform one or more security operations using the HFN and a PDCP SN associated with the HFN. Additionally or alternatively, the communication manager 150 or 155 may communicate an indication of a HFN that includes one or more most significant bits of a SFN; and perform one or more security operations using the HFN and a PDCP SN associated with the HFN. Additionally or alternatively, the communication manager 150 or 155 may perform one or more other operations described herein.

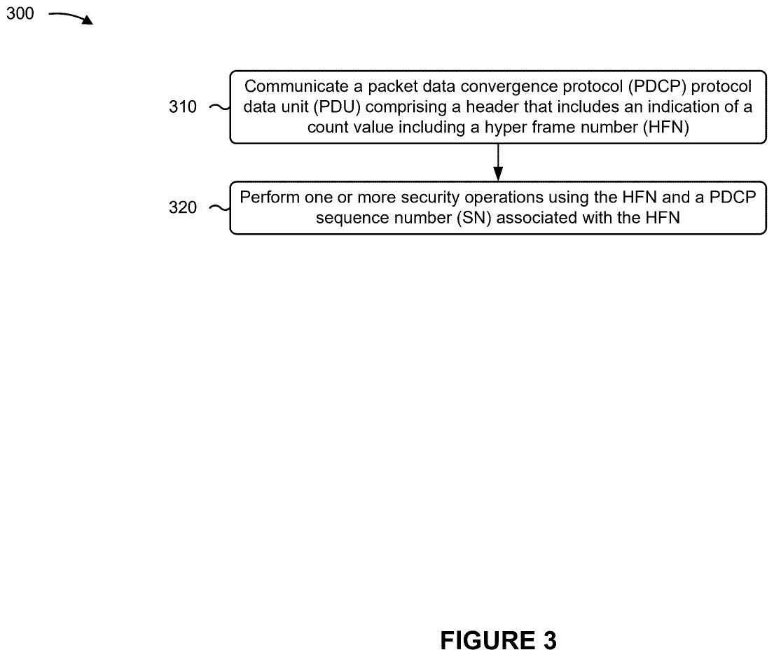

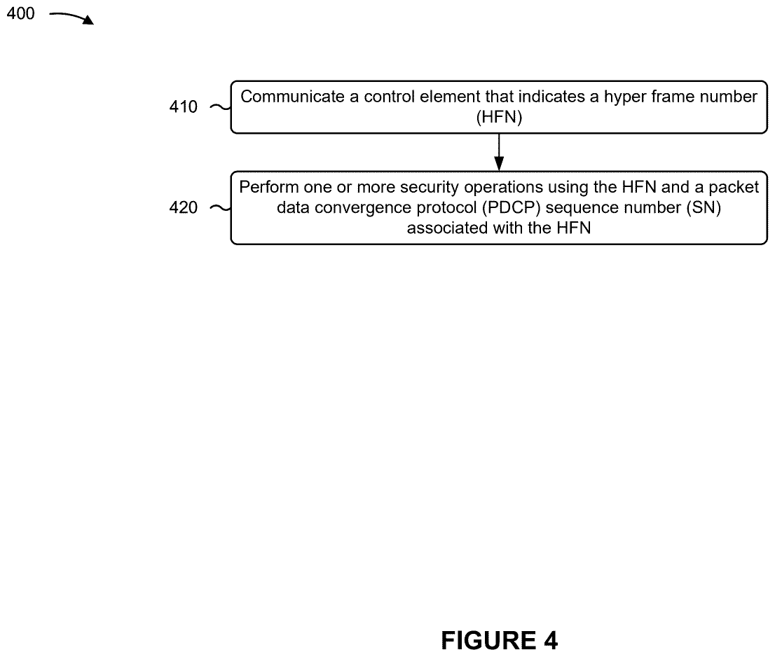

The network node 110, the processing system 145 of the network node 110, the UE 120, the processing system 140 of the UE 120, a CU, a DU, an RU, or any other component(s) of FIG. 1 may implement one or more techniques or perform one or more operations associated with indicating a HFN, as described in more detail elsewhere herein. In some aspects, the wireless communication device described herein is the UE 120, is included in the UE 120, includes one or more components of the UE 120 shown in FIG. 1, is the network node 110, is included in the network node 110, or includes one or more components of the network node 110 shown in FIG. 1. For example, the processing system 145 of the network node 110, the processing system 140 of the UE 120, a CU, a DU, or an RU may perform or direct operations of, for example, process 300 of FIG. 3, process 400 of FIG. 4, or other processes as described herein (alone or in conjunction with one or more other processors). Memory of the network node 110 may store data and program code (or instructions) for the network node 110, a CU, a DU, or an RU. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, a CU, a DU, or an RU, may cause the one or more processors to perform process 300 of FIG. 3, process 400 of FIG. 4, or other processes as described herein. In some examples, executing instructions may include running the instructions, converting the instructions, compiling the instructions, or interpreting the instructions, among other examples.

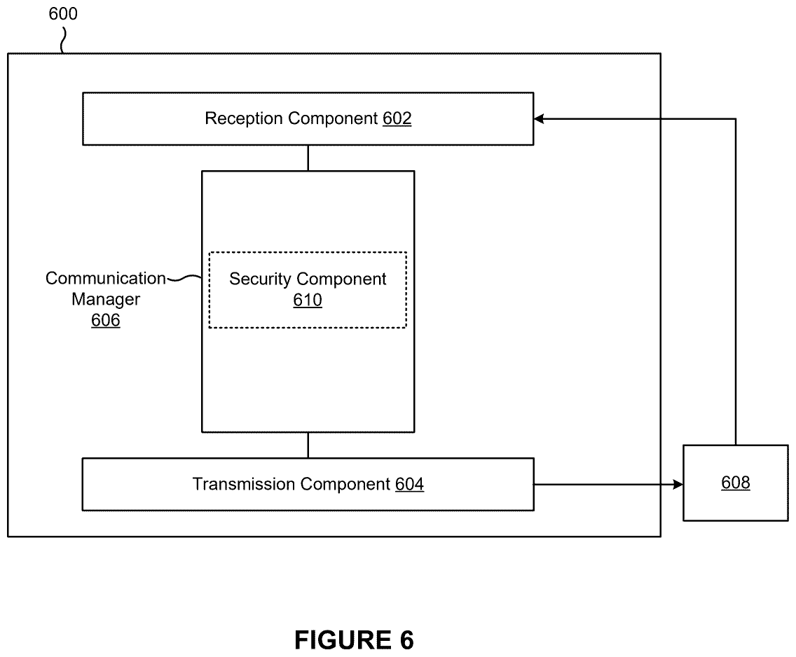

In some aspects, the wireless communication device includes means for communicating a PDCP PDU comprising a header that includes an indication of a count value including a HFN; or means for performing one or more security operations using the HFN and a PDCP SN associated with the HFN. In some aspects, the wireless communication device includes means for communicating a control element that indicates a HFN; or means for performing one or more security operations using the HFN and a PDCP SN associated with the HFN. In some aspects, the wireless communication device includes means for communicating an indication of a HFN that includes one or more most significant bits of a SFN; or means for performing one or more security operations using the HFN and a PDCP SN associated with the HFN. In some aspects, the means for the wireless communication device to perform operations described herein may include, for example, one or more of communication manager 150, communication manager 155, processing system 140, processing system 145, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

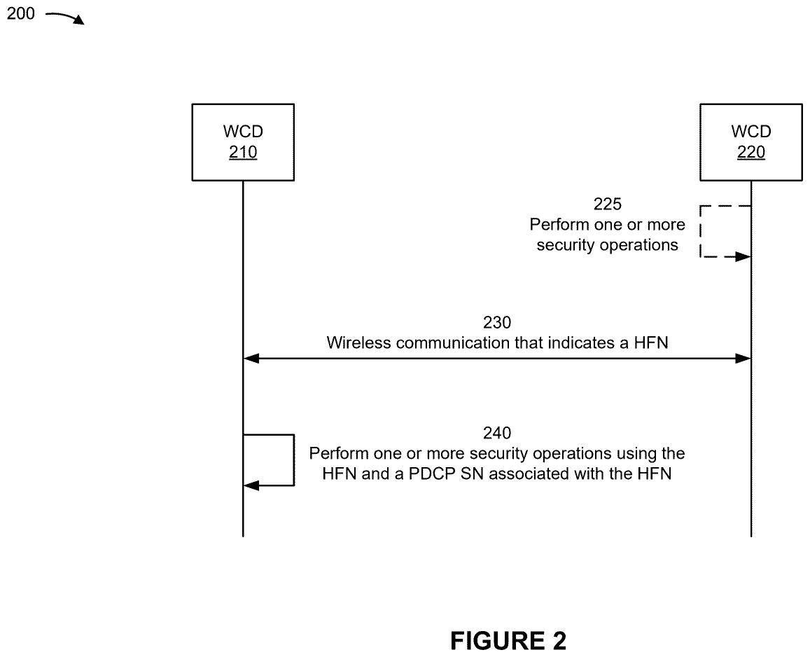

FIG. 2 is a diagram illustrating an example 200 associated with indicating a HFN, in accordance with the present disclosure. As shown in FIG. 2, a wireless communication device (“WCD”) 210 and a wireless communication device 220 may communicate with one another. In some aspects, the wireless communication device 210 may be a network node 110 (as shown in FIG. 1), and the wireless communication device 220 may be a UE 120 (as shown in FIG. 1). In some aspects, the wireless communication device 210 may be a UE 120 (as shown in FIG. 1), and the wireless communication device 220 may be a network node 110 (as shown in FIG. 1).

In a first operation 225, the wireless communication device 220 may perform one or more security operations. For example, the wireless communication device 220 may perform the one or more security operations using one or more of a HFN or a PDCP SN associated with the HFN. In some examples, the wireless communication device 220 may perform one or more security operations using a count value (for example, a PDCP count value). For example, the wireless communication device 220 may concatenate the HFN and the PDCP SN to generate the count value. The one or more security operations may include encryption (such as ciphering) or integrity protection, among other examples.

In a second operation 230, the wireless communication device 210 may communicate a wireless communication that indicates a HFN. The wireless communication device 210 may communicate the wireless communication that indicates the HFN in that the wireless communication device 210 may transmit or receive the wireless communication that indicates the HFN. In some examples, the wireless communication device 210 may transmit, and the wireless communication device 220 may receive, the wireless communication that indicates the HFN. In some examples (such as where the wireless communication device 220 performs one or more security operations as discussed above in connection with the first operation 225), the wireless communication device 220 may transmit, and the wireless communication device 210 may receive, the wireless communication that indicates the HFN.

In some aspects, the wireless communication may comprise a PDCP PDU comprising a header that includes an indication of a count value including the HFN. For example, the PDCP PDU (for example, a PDCP packet) may include the header (for example, a PDCP header). The count value may be a value of a PDCP count, which may be a concatenation of the HFN and a PDCP SN. In some examples, the HFN and the PDCP SN may be indicated in the same header. For example, the entire count value (including both the HFN and the PDCP SN) may be included in the header of the PDCP PDU. For example, the entire count value may be included in the header of each PDCP PDU. In some examples, the HFN and the PDCP SN may be indicated in different headers (for example, headers of different PDCP PDUs). For example, the HFN may be indicated in a PDCP control PDU, and the PDCP SN may be indicated in a PDCP data PDU. For example, the PDCP control PDU and the PDCP data PDU may be in the same TB. In some examples, the header may use 14-20 bits to indicate the HFN. For example, the header may allocate three bytes for the HFN in examples involving a 12-bit PDCP SN, and two bytes for the HFN in examples involving an 18-bit PDCP SN. In some examples, count value may be used for MAC TB-level security (for example, the same count value may be used for a large PDU set).

In some aspects, the count value may be associated with a data radio bearer. A data radio bearer may be a virtual channel that transports data. The data may be user data, such as Internet traffic or application traffic, among other examples. The count value may be associated with the data radio bearer in that the count value may increment for each PDCP data PDU that is transmitted using the data radio bearer. For example, the header may include the entire count value for the data radio bearer.

In some aspects, the count value may be associated with a signaling radio bearer. A data radio bearer may be a virtual channel that transports signaling messages. The signaling messages may be control messages, such as RRC messages or non-access stratum (NAS) messages, among other examples. The count value may be associated with the signaling radio bearer in that the count value may increment for each PDCP data PDU that is transmitted using the signaling radio bearer. For example, the header may include the entire count value for the signaling radio bearer.

In some aspects, the wireless communication device 210 may communicate the PDCP PDU in accordance with a change associated with the HFN. For example, the header may include the HFN in response to the HFN changing (for example, incrementing). In examples where a HFN has not changed (for example, is the same as a HFN associated with a previous PDCP PDU), the wireless communication device 210 may refrain from including that HFN in a header.

In some aspects, the PDCP PDU may be a first PDCP PDU of a radio bearer in a TB. For example, the header may include the HFN in response to the PDCP PDU being the first (for example, initial) PDCP PDU in the TB. In some examples, the wireless communication device 210 may refrain from including a HFN in a header that does not belong to a first PDCP PDU of a radio bearer in the TB.

In some aspects, the wireless communication device 210 may communicate another PDCP PDU having a header that includes an indication of a PDCP SN associated with the HFN. The PDCP SN may be associated with the HFN in that the PDCP SN may be concatenated with the HFN to produce a count value. In some examples, the header of the other PDCP PDU may not include the HFN. For example, the wireless communication device 210 may communicate headers that include the PDCP SN (and not the HFN) until the HFN changes again, or if the HFN incremented after the PDCP PDU was generated and before the PDCP PDU was transmitted. In some examples, the wireless communication device 210 may use a first header type to transmit the indication of the count value including the HFN, and a second header type to transmit the indication of the PDCP PDU.

In some aspects, the wireless communication may comprise a control element that indicates the HFN. For example, the control element may include an indication of the HFN. In some aspects, the control element may be a MAC-CE. In some examples, the MAC-CE may list a current HFN for each of the signaling radio bearers or data radio bearers with data present in the transport block. In some aspects, the control element may be a PDCP PDU.

In some aspects, the HFN may be associated with a single logical channel (LC). A LC may carry a specific type of traffic. For example, a LC may be a control channel (which carries control information) or a traffic channel (which carries data, such as user data). The HFN may be associated with the single LC in that the HFN may apply to the single LC (for example, different HFNs may apply to respective LCs).

In some aspects, the HFN may be associated with a plurality of LCs. The HFN may be associated with the plurality of LCs in that the HFN may apply to each LC of the plurality of LCs. For example, the HFN may be shared among the plurality of LCs.

In some aspects, the control element may be an only control element that indicates the HFN in a TB. For example, the wireless communication device 210 may communicate the control element once per TB. In some examples, the wireless communication device 210 may also receive a PDCP SN in each PDU in the TB. Upon decoding the TB, a receiver (for example, the wireless communication device 210 or the wireless communication device 220) may generate one or more count values using the HFN indicated in the control element and one or more PDCP SNs indicated in each PDU in the TB.

In some aspects, the wireless communication device 210 may communicate the control element in accordance with a change associated with the HFN. For example, the wireless communication device 210 may communicate the control element in response to the HFN changing (for example, incrementing). In some examples, the wireless communication device 210 may also receive a PDCP SN in each PDU to which the HFN indicated in the control element applies. Upon decoding the control element and the PDUs, a receiver (for example, the wireless communication device 210 or the wireless communication device 220) may generate one or more count values using the HFN indicated in the control element and one or more PDCP SNs indicated in each PDU.

In some aspects, the wireless communication may comprise an indication of the HFN that includes one or more most significant bits of a SFN. A SFN may index radio frames, be a 10-bit value, and be transmitted in a broadcast channel. In some examples, the HFN may include 7 significant bits of the SFN. For example, the HFN may drop the 3 least significant bits of a 10-bit SFN.

In some aspects, the HFN may further include one or more bits of a tag. The tag may be an h-bit tag, where h is a small number such as 3 or fewer. In some aspects, the one or more bits of the tag may be indicated in a PDCP PDU. For example, each TB may include one PDCP control element (for example, the PDCP PDU) that indicates h least significant bits of the HFN at the time of a first transmission of a PDCP SN. In some aspects, the one or more bits of the tag may be a HARQ identifier. For example, the tag may be the HARQ identifier that is used to carry a TB.

In some aspects, the HFN may further include one or more bits of a SSFN. An SSFN may increment each time an SFN rolls over. In some examples, the HFN may be a concatenation of the SSFN, the one or more most significant bits of the SFN, and the h-bit tag. For example, the HFN may be represented as follows: HFN=SSFN |one or more most significant bits of the SFN |h-bit tag. In some examples, a HFN of this form may be referred to as an “nHFN.” In some aspects, the SSFN may be indicated via a control channel. In some aspects, the control channel may be a broadcast control channel (BCCH), a common control channel (CCCH), or a dedicated control channel (DCCH).

In a third operation 240, the wireless communication device 210 may perform one or more security operations using the HFN and a PDCP SN associated with the HFN. For example, the wireless communication device 210 may perform one or more security operations using a count value (for example, a PDCP count value). For example, the wireless communication device 210 may concatenate the HFN and the PDCP SN to generate the count value. The one or more security operations may include encryption (such as ciphering), decryption (such as deciphering), integrity protection, or message authentication, among other examples. In some examples (such as where the wireless communication device 220 performs one or more security operations as discussed above in connection with the first operation 225 and transmits the wireless communication that indicates the HFN to the wireless communication device 210), the one or more security operations may include decryption (such as deciphering), integrity protection, or message authentication, among other examples. For example, the wireless communication device 220 may encrypt a message using the HFN and indicate the HFN to the wireless communication device 210, which may use the HFN to decrypt the message.

Communicating the PDCP PDU comprising the header that includes the indication of the count value including the HFN may help to prevent communication failures, such as by facilitating the one or more security operations, among other examples. For example, instead of relying on local monitoring (for example, where respective PDCP entities monitor the HFN independently from each other, which can lead to HFN out-of-sync), the wireless communication device 210 may use HFN indicated in the wireless communication to remain synchronized with the wireless communication device 220 with respect to the HFN. In some examples, the PDCP PDU comprising the header that includes the indication of the count value including the HFN may help to prevent communication failures in high-throughput scenarios.

Communicating the control element that indicates the HFN may help to prevent communication failures using reduced overhead. For example, the control element may be transmitted relatively infrequently (for example, compared to the PDCP PDU comprising the header that includes the indication of the count value including the HFN).

Communicating the indication of the HFN that includes one or more most significant bits of the SFN may help to prevent communication failures in high-throughput scenarios, such as for short PDCP SN rollover periods. For example, the HFN may increment fast enough such that the PDCP SN does not roll over before the HFN increments. For example, a PDCP SN may be selected such that the rollover period is greater than 80 ms, and removing the 3 least significant bits of the SFN may cause the HFN to increment every 80 ms.

The HFN further including the one or more bits of the tag may help the PDCP SN may remain tied to a TB (for example, a TB that includes the one or more bits of the tag). For example, due to HARQ procedures, an indication of a PDCP SN x that was first transmitted in a HFN y may eventually be received in HFN y+k, where k is a positive number greater than 0; as the PDCP SN x progresses through HARQ retransmission, the PDCP SN may remain tied to the TB (at least in examples where the HARQ retransmission does not span more than 2^{h} SFNs, where h is a quantity of bits in an h-bit tag as described elsewhere herein).

The one or more bits of the tag being the HARQ identifier may help to reduce overhead. For example, the HARQ identifier may be transmitted in the PDCCH regardless of whether the wireless communication device 210 communicates the indication of the HFN that includes one or more most significant bits of the SFN.

The HFN further including the SSFN may enable the HFN to roll over after a sufficiently long time because a re-key may be required upon HFN rollover, and a 10-bit SFN may be too small. For example, the HFN including the SSFN may provide additional most significant bits to augment the SFN.

FIG. 3 is a flowchart illustrating an example process 300 performed, for example, at a wireless communication device or an apparatus of a wireless communication device that supports one or more first aspects for indicating a HFN in accordance with the present disclosure. Example process 300 is an example where the apparatus or the wireless communication device (for example, network node 110 or UE 120) performs operations associated with indicating a HFN.

As shown in FIG. 3, in some aspects, process 300 may include communicating a PDCP PDU comprising a header that includes an indication of a count value including a HFN (block 310). For example, the wireless communication device (such as by using communication manager 606, reception component 602, or transmission component 604, depicted in FIG. 6) may communicate a PDCP PDU comprising a header that includes an indication of a count value including a HFN, as described above in connection with operation 230.

As further shown in FIG. 3, in some aspects, process 300 may include performing one or more security operations using the HFN and a PDCP SN associated with the HFN (block 320). For example, the wireless communication device (such as by using communication manager 606 or security component 610, depicted in FIG. 6) may perform one or more security operations using the HFN and a PDCP SN associated with the HFN, as described above in connection with operation 240.

Process 300 may include additional aspects, such as any single aspect or any combination of aspects described below or in connection with one or more other processes described elsewhere herein.

In a first additional aspect, the count value is associated with a data radio bearer.

In a second additional aspect, alone or in combination with the first aspect, the count value is associated with a signaling radio bearer.

In a third additional aspect, alone or in combination with one or more of the first and second aspects, communicating the PDCP PDU includes communicating the PDCP PDU in accordance with a change associated with the HFN.

In a fourth additional aspect, alone or in combination with one or more of the first through third aspects, the PDCP PDU is a first PDCP PDU of a radio bearer in a TB.

In a fifth additional aspect, alone or in combination with one or more of the first through fourth aspects, the PDCP PDU is a first PDCP PDU, the header is a first header, the PDCP SN is a first PDCP SN, and process 300 includes communicating a second PDCP PDU having a second header that includes an indication of a second PDCP SN associated with the HFN.

Although FIG. 3 shows example blocks of process 300, in some aspects, process 300 may include additional blocks, fewer blocks, different blocks, or differently arranged blocks than those depicted in FIG. 3. Additionally or alternatively, two or more of the blocks of process 300 may be performed in parallel.

FIG. 4 is a flowchart illustrating an example process 400 performed, for example, at a wireless communication device or an apparatus of a wireless communication device that supports one or more second aspects for indicating a HFN in accordance with the present disclosure. Example process 400 is an example where the apparatus or the wireless communication device (for example, network node 110 or UE 120) performs operations associated with indicating a HFN.

As shown in FIG. 4, in some aspects, process 400 may include communicating a control element that indicates a HFN (block 410). For example, the wireless communication device (such as by using communication manager 606, reception component 602, or transmission component 604, depicted in FIG. 6) may communicate a control element that indicates a HFN, as described above in connection with operation 230.

As further shown in FIG. 4, in some aspects, process 400 may include performing one or more security operations using the HFN and a PDCP SN associated with the HFN (block 420). For example, the wireless communication device (such as by using communication manager 606 or security component 610, depicted in FIG. 6) may perform one or more security operations using the HFN and a PDCP SN associated with the HFN, as described above in connection with operation 240.

Process 400 may include additional aspects, such as any single aspect or any combination of aspects described below or in connection with one or more other processes described elsewhere herein.

In a first additional aspect, the control element is an only control element that indicates the HFN in a transport block.

In a second additional aspect, alone or in combination with the first aspect, communicating the control element includes communicating the control element in accordance with a change associated with the HFN.

In a third additional aspect, alone or in combination with one or more of the first and second aspects, the control element is a MAC-CE.

In a fourth additional aspect, alone or in combination with one or more of the first through third aspects, the control element is a PDCP PDU.

In a fifth additional aspect, alone or in combination with one or more of the first through fourth aspects, the HFN is associated with a single logical channel.

In a sixth additional aspect, alone or in combination with one or more of the first through fifth aspects, the HFN is associated with a plurality of logical channels.

Although FIG. 4 shows example blocks of process 400, in some aspects, process 400 may include additional blocks, fewer blocks, different blocks, or differently arranged blocks than those depicted in FIG. 4. Additionally or alternatively, two or more of the blocks of process 400 may be performed in parallel.

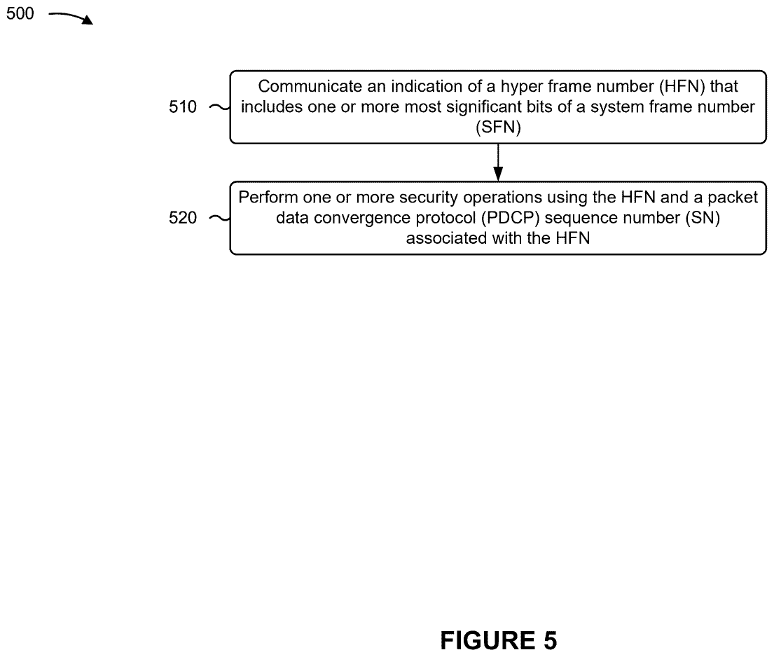

FIG. 5 is a flowchart illustrating an example process 500 performed, for example, at a wireless communication device or an apparatus of a wireless communication device that supports one or more third aspects for indicating a HFN in accordance with the present disclosure. Example process 500 is an example where the apparatus or the wireless communication device (for example, network node 110 or UE 120) performs operations associated with indicating a HFN.

As shown in FIG. 5, in some aspects, process 500 may include communicating an indication of a HFN that includes one or more most significant bits of a SFN (block 510). For example, the wireless communication device (such as by using communication manager 606, reception component 602, or transmission component 604, depicted in FIG. 6) may communicate an indication of a HFN that includes one or more most significant bits of a SFN, as described above in connection with operation 230.

As further shown in FIG. 5, in some aspects, process 500 may include performing one or more security operations using the HFN and a PDCP SN associated with the HFN (block 520). For example, the wireless communication device (such as by using communication manager 606 or security component 610, depicted in FIG. 6) may perform one or more security operations using the HFN and a PDCP SN associated with the HFN, as described above in connection with operation 240.

Process 500 may include additional aspects, such as any single aspect or any combination of aspects described below or in connection with one or more other processes described elsewhere herein.

In a first additional aspect, the HFN further includes one or more bits of a tag.

In a second additional aspect, alone or in combination with the first aspect, the one or more bits of the tag are indicated in a PDCP PDU.

In a third additional aspect, alone or in combination with one or more of the first and second aspects, the one or more bits of the tag are a HARQ identifier.

In a fourth additional aspect, alone or in combination with one or more of the first through third aspects, the HFN further includes a SSFN.

In a fifth additional aspect, alone or in combination with one or more of the first through fourth aspects, the SSFN is indicated via a control channel.

In a sixth additional aspect, alone or in combination with one or more of the first through fifth aspects, the control channel is a broadcast control channel, a common control channel, or a dedicated control channel.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a diagram of an example apparatus 600 for wireless communication that supports indicating a HFN in accordance with the present disclosure. The apparatus 600 may be a wireless communication device (for example, a network node 110 or a UE 120), or a wireless communication device (for example, a network node 110 or a UE 120) may include the apparatus 600. In some aspects, the apparatus 600 includes a reception component 602, a transmission component 604, and a communication manager 606, which may be in communication with one another (for example, via one or more buses). As shown, the apparatus 600 may communicate with another apparatus 608 (such as a UE 120, a network node 110, or another wireless communication device) using the reception component 602 and the transmission component 604. The communication manager 606 may be included in, or implemented via, a processing system (for example, the processing system 140 or 145). In some aspects, the communication manager 606 is the communication manager 150 or 155.

In some aspects, the apparatus 600 may be configured to or operable to perform one or more operations described herein in connection with FIG. 2. Additionally or alternatively, the apparatus 600 may be configured to or operable to perform one or more processes described herein, such as process 300 of FIG. 3, process 400 of FIG. 4, or process 500 of FIG. 5.

The reception component 602 may receive communications, such as reference signals, control information, or data communications, from the apparatus 608. The reception component 602 may provide received communications to one or more other components of the apparatus 600, such as the communication manager 606. In some aspects, the reception component 602 may perform signal processing on the received communications, and may provide the processed signals to the one or more other components in a similar manner as described above in connection with FIG. 1. In some aspects, the reception component 602 may include one or more components of the wireless communication device described above in connection with FIG. 1, such as a radio, one or more RF chains, one or more transceivers, or one or more modems, each of which may in turn be coupled with one or more antennas of the wireless communication device.

The transmission component 604 may transmit communications, such as reference signals, control information, or data communications, to the apparatus 608. In some aspects, the communication manager 606 may generate communications and may transmit the generated communications to the transmission component 604 for transmission to the apparatus 608. In some aspects, the transmission component 604 may perform signal processing on the generated communications, and may transmit the processed signals to the apparatus 608 in a similar manner as described above in connection with FIG. 1. In some aspects, the transmission component 604 may include one or more components of the wireless communication device described above in connection with FIG. 1, such as a radio, one or more RF chains, one or more transceivers, or one or more modems, each of which may in turn be coupled with one or more antennas of the wireless communication device. In some aspects, the transmission component 604 may be co-located with the reception component 602.

The communication manager 606 may communicate a PDCP PDU comprising a header that includes an indication of a count value including a HFN. The communication manager 606 may perform one or more security operations using the HFN and a PDCP SN associated with the HFN. In some aspects, the communication manager 606 may perform one or more operations described elsewhere herein as being performed by one or more components of the communication manager 606.

The communication manager 606 may communicate a control element that indicates a HFN. The communication manager 606 may perform one or more security operations using the HFN and a PDCP SN associated with the HFN. In some aspects, the communication manager 606 may perform one or more operations described elsewhere herein as being performed by one or more components of the communication manager 606.

The communication manager 606 may communicate an indication of a HFN that includes one or more most significant bits of a SFN. The communication manager 606 may perform one or more security operations using the HFN and a PDCP SN associated with the HFN. In some aspects, the communication manager 606 may perform one or more operations described elsewhere herein as being performed by one or more components of the communication manager 606.

In some aspects, the communication manager 606 includes a set of components, such as a security component 610. Alternatively, the set of components may be separate and distinct from the communication manager 606. As used herein, the term “component” is intended to be broadly construed as hardware or a combination of hardware and at least one of software or firmware. In some aspects, one or more components of the set of components may include or may be implemented within a processing system (for example, the processing system 140 or 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 602 or the transmission component 604 may communicate a PDCP PDU comprising a header that includes an indication of a count value including a HFN. The reception component 602 or the transmission component 604 may communicate a control element that indicates a HFN. The reception component 602 or the transmission component 604 may communicate an indication of a HFN that includes one or more most significant bits of a SFN. The security component 610 may perform one or more security operations using the HFN and a PDCP SN associated with the HFN.

The quantity and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally or alternatively, a set of (one or more) components shown in FIG. 6 may perform one or more functions described as being performed by another set of components shown in FIG. 6.

The following provides an overview of some Aspects of the present disclosure:
Aspect 1: A method of wireless communication performed at a wireless communication device, comprising: communicating a packet data convergence protocol (PDCP) protocol data unit (PDU) comprising a header that includes an indication of a count value including a hyper frame number (HFN); and performing one or more security operations using the HFN and a PDCP sequence number (SN) associated with the HFN.
Aspect 2: The method of Aspect 1, wherein the count value is associated with a data radio bearer.
Aspect 3: The method of any of Aspects 1-2, wherein the count value is associated with a signaling radio bearer.
Aspect 4: The method of any of Aspects 1-3, wherein communicating the PDCP PDU includes communicating the PDCP PDU in accordance with a change associated with the HFN.
Aspect 5: The method of any of Aspects 1-4, wherein the PDCP PDU is a first PDCP PDU of a radio bearer in a transport block.
Aspect 6: The method of any of Aspects 1-5, wherein the PDCP PDU is a first PDCP PDU, the header is a first header, and the PDCP SN is a first PDCP SN, the method further comprising: communicating a second PDCP PDU having a second header that includes an indication of a second PDCP SN associated with the HFN.
Aspect 7: A method of wireless communication performed at a wireless communication device, comprising: communicating a control element that indicates a hyper frame number (HFN); and performing one or more security operations using the HFN and a packet data convergence protocol (PDCP) sequence number (SN) associated with the HFN.
Aspect 8: The method of Aspect 7, wherein the control element is an only control element that indicates the HFN in a transport block.
Aspect 9: The method of any of Aspects 7-8, wherein communicating the control element includes communicating the control element in accordance with a change associated with the HFN.
Aspect 10: The method of any of Aspects 7-9, wherein the control element is a medium access control (MAC) control element (MAC-CE).
Aspect 11: The method of any of Aspects 7-10, wherein the control element is a PDCP protocol data unit (PDU).
Aspect 12: The method of any of Aspects 7-11, wherein the HFN is associated with a single logical channel.
Aspect 13: The method of any of Aspects 7-12, wherein the HFN is associated with a plurality of logical channels.
Aspect 14: A method of wireless communication performed at a wireless communication device, comprising: communicating an indication of a hyper frame number (HFN) that includes one or more most significant bits of a system frame number (SFN); and performing one or more security operations using the HFN and a packet data convergence protocol (PDCP) sequence number (SN) associated with the HFN.
Aspect 15: The method of Aspect 14, wherein the HFN further includes one or more bits of a tag.
Aspect 16: The method of Aspect 15, wherein the one or more bits of the tag are indicated in a PDCP protocol data unit (PDU).
Aspect 17: The method of Aspect 15, wherein the one or more bits of the tag are a hybrid automatic repeat request (HARQ) identifier.
Aspect 18: The method of any of Aspects 14-17, wherein the HFN further includes a system sub-frame number (SSFN).
Aspect 19: The method of Aspect 18, wherein the SSFN is indicated via a control channel.
Aspect 20: The method of Aspect 19, wherein the control channel is a broadcast control channel, a common control channel, or a dedicated control channel.
Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.
Aspect 22: An apparatus for wireless communication at a device, the apparatus comprising one or more memories and one or more processors coupled to the one or more memories, the one or more processors configured to cause the device to perform the method of one or more of Aspects 1-20.
Aspect 23: An apparatus for wireless communication, the apparatus comprising at least one means for performing the method of one or more of Aspects 1-20.
Aspect 24: A non-transitory computer-readable medium storing code for wireless communication, the code comprising instructions executable by one or more processors to perform the method of one or more of Aspects 1-20.
Aspect 25: A non-transitory computer-readable medium storing a set of instructions for wireless communication, the set of instructions comprising one or more instructions that, when executed by one or more processors of a device, cause the device to perform the method of one or more of Aspects 1-20.
Aspect 26: A device for wireless communication, the device comprising a processing system that includes one or more processors and one or more memories coupled with the one or more processors, the processing system configured to cause the device to perform the method of one or more of Aspects 1-20.
Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a wireless communication device, comprising:
one or more memories storing processor-executable code; and
one or more processors coupled with the one or more memories, at least one processor of the one or more processors configured to cause the wireless communication device to:
communicate a packet data convergence protocol (PDCP) protocol data unit (PDU) comprising a header that includes an indication of a count value including a hyper frame number (HFN); and
perform one or more security operations using the HFN and a PDCP sequence number (SN) associated with the HFN.

2. The apparatus of claim 1, wherein the count value is associated with a data radio bearer.

3. The apparatus of claim 1, wherein the count value is associated with a signaling radio bearer.

4. The apparatus of claim 1, wherein the at least one processor, to cause the wireless communication device to communicate the PDCP PDU, is configured to cause the wireless communication device to communicate the PDCP PDU in accordance with a change associated with the HFN.

5. The apparatus of claim 1, wherein the PDCP PDU is a first PDCP PDU of a radio bearer in a transport block.

6. The apparatus of claim 1, wherein the PDCP PDU is a first PDCP PDU, the header is a first header, and the PDCP SN is a first PDCP SN, and wherein at least one processor of the one or more processors is configured to cause the wireless communication device to:
communicate a second PDCP PDU having a second header that includes an indication of a second PDCP SN associated with the HFN.

7. An apparatus for wireless communication at a wireless communication device, comprising:
one or more memories storing processor-executable code; and
one or more processors coupled with the one or more memories, at least one processor of the one or more processors configured to cause the wireless communication device to:
communicate a control element that indicates a hyper frame number (HFN); and
perform one or more security operations using the HFN and a packet data convergence protocol (PDCP) sequence number (SN) associated with the HFN.

8. The apparatus of claim 7, wherein the control element is an only control element that indicates the HFN in a transport block.

9. The apparatus of claim 7, wherein the at least one processor, to cause the wireless communication device to communicate the control element, is configured to cause the wireless communication device to communicate the control element in accordance with a change associated with the HFN.

10. The apparatus of claim 7, wherein the control element is a medium access control (MAC) control element (MAC-CE).

11. The apparatus of claim 7, wherein the control element is a PDCP protocol data unit (PDU).

12. The apparatus of claim 7, wherein the HFN is associated with a single logical channel.

13. The apparatus of claim 7, wherein the HFN is associated with a plurality of logical channels.

14. An apparatus for wireless communication at a wireless communication device, comprising:
one or more memories storing processor-executable code; and
one or more processors coupled with the one or more memories, at least one processor of the one or more processors configured to cause the wireless communication device to:
communicate an indication of a hyper frame number (HFN) that includes one or more most significant bits of a system frame number (SFN); and
perform one or more security operations using the HFN and a packet data convergence protocol (PDCP) sequence number (SN) associated with the HFN.

15. The apparatus of claim 14, wherein the HFN further includes one or more bits of a tag.

16. The apparatus of claim 15, wherein the one or more bits of the tag are indicated in a PDCP protocol data unit (PDU).

17. The apparatus of claim 15, wherein the one or more bits of the tag are a hybrid automatic repeat request (HARQ) identifier.

18. The apparatus of claim 14, wherein the HFN further includes a system sub-frame number (SSFN).

19. The apparatus of claim 18, wherein the SSFN is indicated via a control channel.

20. The apparatus of claim 19, wherein the control channel is a broadcast control channel, a common control channel, or a dedicated control channel.
